(19) United States
(12) Patent Application Publication
(10) Pub. No.: US 2003/0116656 A1
(43) Pub. Date: Jun. 26, 2003

(54) Fuel injection valve

(76) Inventor: Guenther Hohl, Stuttgart (DE)

Correspondence Address: KENYON & KENYON, ONE BROADWAY, NEW YORK, NY, 10004, US

(21) Appl. No.: 10/169,245

(22) PCT Filed: Dec. 22, 2000
(86) PCT No.: PCT/DE00/04619

(30) Foreign Application Priority Data
Dec. 29, 1999 (DE) 199 63 568.4

(51) Int. Cl. B05B 1/30; F02M 51/00

(52) U.S. Cl. 239/585.1

(57) ABSTRACT

A fuel injector (1), especially a fuel injector (1) for injection systems of internal combustion engines, includes a solenoid which works together with an armature and a valve needle (15) to actuate a valve-closure member (22), which together with a valve-seat surface (24) forms a sealing seat. A longitudinal axis (28) of the valve needle (15) is inclined by a prescribed angle (γ) with respect to a longitudinal axis (29) of a valve housing (11). The armature is linked with an actuating body (12) whose longitudinal axis (29) is inclined with respect to the longitudinal axis (28) of the valve needle (15) and which acts on the valve needle (15) through a hydraulic device (13).

### BACKGROUND INFORMATION

The present invention relates to a fuel injector according to the preamble of the main claim.

A fuel injector according to the preamble of the main claim is already known from German Patent Application 197 12 591 A1. The fuel injector deriving from that publication has a valve-closure member actuatable by an actuator using a valve needle, which valve-closure member cooperates with a valve-seat surface to form a sealing seat. The fuel injector has a connecting part and a functional part. An electrical connection and a fuel connection are provided on the connecting part. The functional part has the actuator, a compression spring and a valve-seat member on which the valve-seat surface is formed. The entire actuating device necessary for actuating the fuel injector is thus accommodated in the functional part. When the functional part is joined to the connecting part, an electrical contact pin of the functional part is inserted into a socket of the connecting part, whereby the actuator is joined with the electrical connector of the connecting part. In addition, a fuel channel in the functional part is joined with a fuel channel in the connecting part by a leakproof connection. Because the connecting part is chamfered on a connecting side, on which it is joined with the functional part, the functional part can be joined with the connecting part at a fixed pivoting angle.

A disadvantage of the fuel injector known from German Patent Application 197 12 591 A1 is in particular the bend in the valve housing. It makes insertion of the fuel injector into an insertion bore of an internal combustion engine difficult, since the fuel injector cannot be screwed for example into a cylindrical connection piece. In particular, this fuel injector cannot be inserted into a cylindrical insertion bore of a cylinder head, as is necessary for fuel injectors which inject directly into the combustion chamber of the internal combustion engine. Since the fuel injector is subdivided into a connecting part and a functional part, with the entire actuating device accommodated in the functional part, fabrication is very complex.

### ADVANTAGES OF THE INVENTION

The fuel injector according to the present invention having the characterizing features of the main claim has the advantage over the related art that the angle of inclination may be modified independent of the external shape of the valve housing, so that the fuel injector may be utilized flexibly. In addition, the actuating device may be positioned in the fuel injector independently of the angular position of the valve needle, so that the present invention is suitable for any desired fuel injectors with any desired actuators. It is particularly advantageous that the housing of the fuel injector has no bend, so that it may be inserted for example into a cylindrical insertion bore of a cylinder head of an internal combustion engine.

The measures listed in the subclaims make advantageous refinements of the fuel injector described in the main claim possible.

Changes to the angle of inclination are possible through slight changes when manufacturing individual components of the fuel injector, without needing to adapt the entire production process.

The hydraulic device through which the fuel injector is actuated may be used not only for angle conversion, but also to transmit the lift of the actuating body. This makes greater lift of the actuating body possible.

Of particular advantage is the fact that the hydraulic device may be made by advantageous production techniques as an insertable component and may be inserted into the injector valve as a complete component. The hydraulic device is therefore not subject to any great risk of damage during installation.

### DRAWING

One exemplary embodiment of the present invention is illustrated in simplified form in the drawing and explained in greater detail in the following description.

FIG. 1 shows an axial section through an embodiment of a fuel injector designed according to the present invention.

FIG. 2 shows the detail designated in FIG. 1 with II, of the area on the injection side of the fuel injector designed according to the present invention depicted in FIG. 1.

### DESCRIPTION OF THE EXEMPLARY EMBODIMENT

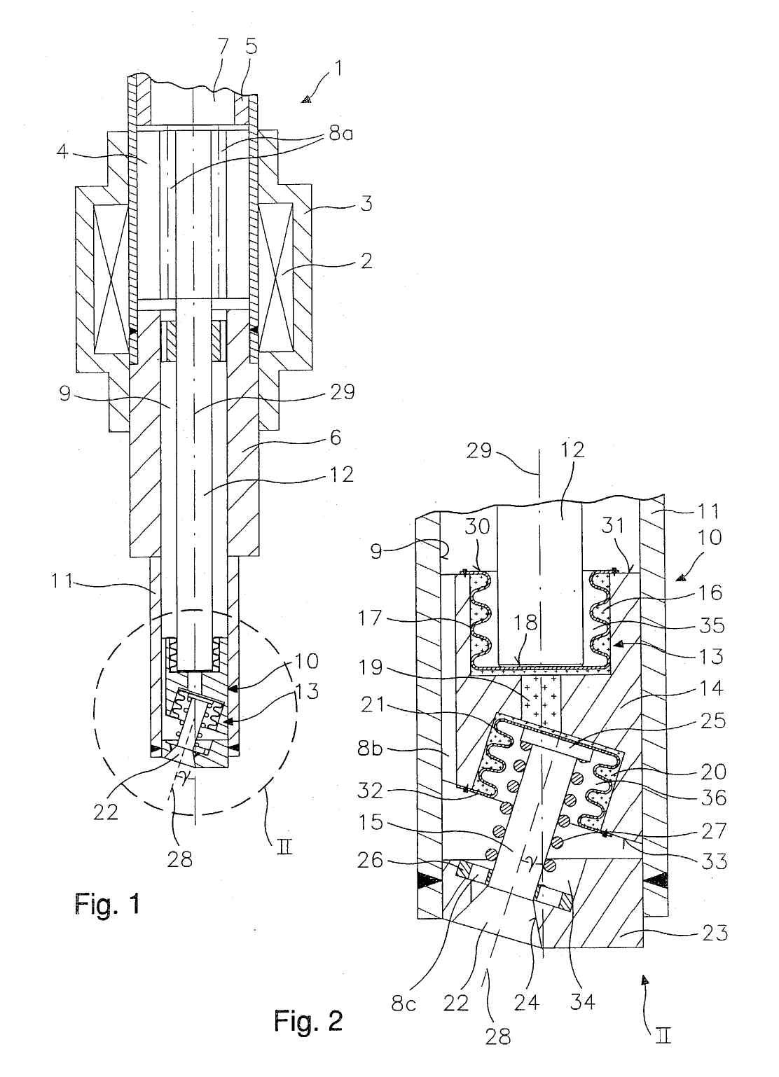

FIG. 1 shows a partial axial sectional depiction of an embodiment of fuel injector 1 designed according to the present invention, which is designed as an outward opening fuel injector 1 and is suitable in particular for direct injection of fuel into a combustion chamber (not shown) of an internal combustion engine having spark ignition and fuel mixture compression.

Fuel injector 1 includes a solenoid 2 which is surrounded by a magnetic reflux body 3, as well as an armature 4 which is positioned between a core 5 and a connecting part 6 and works together with solenoid 2. The fuel is fed in centrally through a fuel supply system 7 and conveyed through fuel channels 8a in armature 4, a central recess 9 in fuel injector 1 and an insertable component 10 on the injection-side end, to the sealing seat. Fuel injector 1 is surrounded on its injection side by a valve housing section 11, into which insertable component 10 may be inserted. Armature 4 is frictionally linked with a plunger-like or valve-needle-like actuating body 12, whose injection-side end acts on insertable component 10. Insertable component 10 is fastened in the correct position to a valve-seat member 23 in valve housing section 11.

Insertable component 10 is made up essentially of a hydraulic device 13, a body 14 which surrounds the hydraulic device 13, a valve needle 15 and a sealing seat 22, 24. The individual components are explained in greater detail in the description of FIG. 2.

FIG. 2 shows an enlarged sectional view of the detail of the injection-side end of fuel injector 1 according to the present invention, identified in FIG. 1 with II.

Hydraulic device 13 is constructed as follows: Actuation body 12 projects into a first recess 35 formed at the infeed-side end of insertable component 10, which recess 35 has a cylindrical cross section in the present embodiment and in which there is a first corrugated tube 17. First corrugated tube 17 is of pot-shaped design and lies with its rim 30 against infeed-side face 31 of insertable component 10. Rim 30 of first corrugated tube 17 may be in particular welded to face 31 of insertable component 10. It seals a first chamber 16 between corrugated tube 17 and the wall of recess 35 against the fuel which is conveyed through a fuel channel 8b between valve housing section 11 and insertable component 10 to sealing seat 22, 24. Actuating body 12 is braced by a lower face 18 against the bottom of first corrugated tube 17. The space between the wall of first recess 35 and first corrugated tube 17 forms first chamber 16, and is filled with a hydraulic medium.

First chamber 16 is connected with a second chamber 20 through a connecting channel 19, which may likewise be cylindrical in shape and is filled with hydraulic medium. Second chamber 20 is formed on the injection-side end of insertable component 10. In a second recess 36, which is in particular cylindrically shaped, a second corrugated tube 21 which is likewise pot-shaped is arranged in the same manner as first corrugated tube 17 in first chamber 16. Second corrugated tube 21 lies with a rim 32 against an infeed-side face 33 of insertable component 10 and may be in particular welded to it to seal second chamber 20 against the fuel. Valve needle 15 projects into second chamber 20. Valve needle 15 is braced by its end with a widening 25 in second recess 36 on the bottom of second corrugated tube 21. On valve needle 15 a valve-closure member 22 is formed in the direction of injection. A valve-seat surface 24 is formed on valve-seat member 23, so that valve-closure member 22 forms the sealing seat with valve-seat surface 24. Between widening 25 and an abutment 26 through which valve needle 15 projects and which has fuel channels 8c, a closing spring 27 is situated. Abutment 26 in the present embodiment is plate-shaped. Abutment 26 may also be designed as a single piece with valve-seat member 23 and be situated in a recess 34 of valve-seat member 23. Closing spring 27 holds fuel injector 1 closed when no current is flowing through solenoid 2.

A longitudinal axis 28 of valve needle 15 is inclined by an angle γ with respect to a longitudinal axis 29 of fuel injector 1 or of actuating body 12. The angle of inclination γ, and with it the injection direction of fuel injector 1, depend only on the shape of valve-seat member 23 and of body 14 which surrounds hydraulic device 13. In the embodiment depicted, infeed-side face 31 of insertable component 10 runs perpendicular to longitudinal axis 29 of actuating body 12, while injection-side face 33 of insertable component 10 has an orientation which deviates by 90°, namely by angle γ, from longitudinal axis 29. If some different angle of inclination γ is to be achieved, it is only necessary to make appropriate changes to the forenamed parts, while the outer shape of fuel injector 1 is preserved.

If an electric exciting current is supplied to solenoid 2, armature 4 is drawn into solenoid 2 in the direction of injection. That causes actuating body 12, which is mechanically linked to armature 4, to also be moved in the direction of injection. Since face 18 of actuating body 12 is in contact with first corrugated tube 17, first corrugated tube 17 is elongated in the direction of injection, and the hydraulic medium which is present between first corrugated tube 17 and the wall of first chamber 16 is thereby displaced. The lift of armature 4 is thus transmitted through actuating body 12 to hydraulic device 13.

If hydraulic medium is displaced from first chamber 16 through the action of actuating body 12, it escapes into connecting channel 19 and second chamber 20. Due to the increase in volume of the hydraulic medium in second chamber 20, second corrugated tube 21 is compressed, whereby valve needle 15, which is in contact with second corrugated tube 21 with widening 25, is moved against the force of closing spring 27 in the direction of injection. The fuel, which flows through fuel channels 8a and central recess 9 of fuel injector 1 in the direction of insertable component 10 and is conveyed through fuel channels 8b in insertable component 10 and fuel channels 8c in abutment 26 to the sealing seat, may be injected into an intake pipe or into a combustion chamber of the internal combustion engine when the valve is open.

If the current which excites solenoid 2 is turned off, the pressure exerted on first corrugated tube 17 by actuating body 12 decreases. As a result, the hydraulic medium may be equalized from second chamber 20 through connecting channel 19 into first chamber 16, so that the tension is removed again from second corrugated tube 21 and valve needle 15 returns to the closed position.

The preferably round cross-sectional areas of first chamber 16 and of second chamber 20 may be chosen equal in size if only a conversion of the angle of lift of armature 4 in hydraulic device 13 is desired. However the possibility also exists of choosing a smaller cross-sectional area for second chamber 20 than the cross-sectional area of first chamber 16, whereby a gearing of a small armature lift into a greater valve needle lift may be achieved.

The present invention is not confined to the embodiment described, but is also suitable in particular for any injection angles desired, as well as for an inward opening fuel injector 1.

What is claimed is:

1. A fuel injector (1), in particular an injector for fuel injection systems of internal combustion engines, having an excitable actuator and a valve needle (15) to actuate a valve-closure member (22), which, together with a valve-seat surface (24), forms a sealing seat; a longitudinal axis (28) of the valve needle (15) being inclined at a predefined angle (γ) to a longitudinal axis (29) of a valve housing (11), wherein the armature (4) is linked to an actuating body (12) whose longitudinal axis (29) is inclined with respect to the longitudinal axis (28) of the valve needle (15), and the actuating body (12) acts on the valve needle (15) through a hydraulic device (13).

2. The fuel injector according to claim 1, wherein the hydraulic device (13) is made up of a first chamber (16), a second chamber (20) and a connecting channel (19) connecting the first chamber (16) and the second chamber (20), which are filled with a hydraulic medium.

3. The fuel injector according to claim 2, wherein the first chamber (16), the second chamber (20) and the connecting channel (19) are formed in an insertable component (10) which is insertable into a central recess (9) of the fuel injector (1) and securable there.

4. The fuel injector according to claim 3, wherein the first chamber (16) is formed at an infeed-side end of the insertable component (10).

5. The fuel injector according to claim 4, wherein one face (18) of the actuating body (12) is in contact with a first corrugated tube (17) which terminates the first chamber (16) on the infeed side.

6. The fuel injector according to claim 5, wherein the first corrugated tube (17) is situated so that it has a rim (30) in contact with an infeed-side face (31) of the insertable component (10) and seals the first chamber (16) from fuel.

7. The fuel injector according to one of claims 3 through 6, wherein the second chamber (20) is formed on an injection-side end of the insertable component (10).

8. The fuel injector according to claim 7, wherein the valve needle (15) is in contact with a second corrugated tube (21) which terminates the second chamber (20) on the injection side.

9. The fuel injector according to claim 8, wherein the second corrugated tube (21) is situated so that it has a rim (32) in contact with an injection-side face (33) of the insertable component (10) and seals the second chamber (20) from the fuel.

10. The fuel injector according to one of claims 2 through 9, wherein the cross-sectional area of the second chamber (20) is less than the cross-sectional area of the first chamber (16).

11. The fuel injector according to claims 6 and 8, wherein the infeed-side face (31) of the insertable component (10) runs perpendicular to the longitudinal axis (29) of the actuating body (12), while the injection-side face (33) of the insertable component is oriented at an angle to the longitudinal axis (29), which deviates from 90° by the magnitude of the angle (γ).
